(19) United States
(12) Patent Application Publication
(10) Pub. No.: US 2010/0114488 A1
(43) Pub. Date: May 6, 2010

(54) Systems and Methods for Locating a Vehicle

(75) Inventors: Oddy Khamharn, Grayslake, IL (US); Guillermo Vidal, Vernon Hills, IL (US)

Correspondence Address: CONTINENTAL AUTOMOTIVE SYSTEMS;TEMIC AUTOMOTIVE OF NORTH AMERICA, INC., 21440 WEST LAKE COOK ROAD, PATENTS AND LICENSES, 7TH FLOOR, DEER PARK, IL, 60010, US

(73) Assignee: TEMIC AUTOMOTIVE OF NORTH AMERICA, INC., Deer Park, IL (US)

(21) Appl. No.: 12/262,191

(22) Filed: Oct. 31, 2008

(51) Int. Cl. G06G 7/78

(52) U.S. Cl. 701/300

(57) ABSTRACT

Methods and systems for locating a vehicle are disclosed, including determining a vehicle location information of a vehicle, and sending the vehicle location information to a mobile device, thereby enabling the mobile device to determine a relative location of the vehicle with respect to the mobile device, in response to the mobile device determining a mobile device location information of the mobile device.

### I. BACKGROUND

The invention relates generally to the field of locating a vehicle using a mobile device.

### II. SUMMARY

In one respect, disclosed is a method for locating a vehicle, the method comprising: determining a vehicle location information of a vehicle; sending the vehicle location information to a mobile device, thereby enabling the mobile device to determine a relative location of the vehicle with respect to the mobile device, in response to the mobile device determining a mobile device location information of the mobile device.

In another respect, disclosed is an apparatus for locating a vehicle, the apparatus comprising: one or more processors; one or more memory units coupled to the one or more processors; a location unit coupled to the one or more processors, the location unit being configured to receive one or more external signals for determining a location of the apparatus; and a communications device coupled to the one or more processors, the communications device being configured to communicate with a mobile device.

In yet another respect, disclosed is a mobile device for locating a vehicle, the mobile device comprising: one or more processors; one or more memory units coupled to the one or more processors; a location unit coupled to the one or more processors, the location unit being configured to receive one or more external signals for determining a location of the mobile device; and a communications device coupled to the one or more processors, the communications device being configured to communicate with the vehicle, the mobile device being configured to: receive a vehicle location information from the vehicle; determine a location information of the mobile device; determine a relative location of the vehicle with respect to the mobile device.

Numerous additional embodiments are also possible.

### III. BRIEF DESCRIPTION OF THE DRAWINGS

Other objects and advantages of the invention may become apparent upon reading the detailed description and upon reference to the accompanying drawings.

FIG. 1 is a block diagram illustrating a system for sending location and/or audio-visual information from a vehicle to a mobile device, in accordance with some embodiments.

FIG. 2 is a block diagram illustrating alternative embodiments of a vehicle having one or more cameras and one or more microphones for capturing and sending audio-visual information to a mobile device, in accordance with some embodiments.

FIG. 3 is a block diagram illustrating a mobile device configured to receive location and/or visual information from a vehicle for the purpose of locating the vehicle, in accordance with some embodiments.

FIG. 4 is a flow diagram illustrating a method for sending location information from a vehicle to a mobile device, in accordance with some embodiments.

FIG. 5 is a flow diagram illustrating a method for sending location and/or audio-visual information to a mobile device, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### IV. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

In some embodiments, location information and/or audio-visual information from a vehicle may be sent to a mobile device for the purpose of enabling the mobile device to locate the vehicle. In some embodiments, vehicle location information may be determined using the global positioning system (GPS). In alternative embodiments, the vehicle location information may also be determined using assisted GPS technology (aGPS) where, in addition to satellite signals, signals from cellular phone towers may be used to increase the accuracy in location determinations and to reduce the time required to acquire location information. In some embodiments, audio-visual information may be acquired using one or more cameras and/or one or more microphones positioned inside and/or outside the vehicle. The location information and/or the audio-visual information may be directly or indirectly sent to a mobile device to enable a user of the mobile device to locate the vehicle.

In some embodiments, the audio-visual information may be acquired using one or more cameras and/or one or more microphones placed inside and/or outside of the vehicle. The audio and visual information may be transmitted to the mobile device, either directly or indirectly, in order to assist the mobile device in locating the vehicle. The audio-visual information may be sent to the mobile device directly using different protocols, or the audio-visual information may be sent to the mobile device indirectly through one or more servers. The visual information may be sent as “snapshots” or as a video stream and may be transmitted at regular intervals, upon request from the mobile device, or upon any other condition. For example, audio-visual information may be sent to the mobile device when the vehicle is turned off. That information may be used, for example, to assist in locating the vehicle. Pictures of where the vehicle was last parked may be transmitted, for example.

In some embodiments, the vehicle may employ dead-reckoning algorithms in order to determine the location of the vehicle after the GPS signal is lost. For example, the vehicle may include accelerometers that can be used to estimate the position of the vehicle. Values for the acceleration of the vehicle, the vehicle's velocity at the time the GPS signal was lost, and the time from when the GPS signal was lost can be used to compute the location of the vehicle after the GPS signal is lost.

In some embodiments, the location information and/or the audio-visual information may be transmitted to a mobile device for the purpose of assisting a user of the mobile device in locating the vehicle. The vehicle may send the information to the mobile device using different protocols including packet data (such as TCP/IP), text messaging, etc. The location information and/or the audio-visual information may be transmitted to the mobile device at regular intervals or the information may be transmitted to the mobile device in response to the mobile device requesting the location information. In some embodiments, the location information and/or the audio-visual information may be transmitted to the mobile device directly or the information may be transmitted to the mobile device indirectly through a server, for example.

In addition, the location information and/or the audio-visual information may be stored in the vehicle. The information may be stored locally at the vehicle, for example, and may be transmitted to the mobile device at a later time when the vehicle is unable to communicate, directly or indirectly, with the mobile device. Cached information may be then transmitted to the mobile device when communication is reestablished. In addition, the information may be recovered at a later time, for example, to determine who and how may have stolen the vehicle.

In some embodiments, the mobile phone may be authenticated by the vehicle or by a server before any location information is provided to the mobile device. In some embodiments, the mobile device may be authenticated using a simple user and password. Alternatively, a pre-assigned encryption key between the vehicle and the mobile device or between the server and the mobile device may be used to authenticate the mobile device and to also encrypt communication with the mobile device. In embodiments where the mobile device is also a mobile telephone, the authentication may be performed by pre-programming one more telephone numbers (from the one or more mobile telephone devices that are allowed to access the information) in the vehicle or in the server. The mobile device may then be authenticated simply by communicating with the vehicle or the server and having the vehicle or the server match the mobile device's telephone number with one of the pre-programmed numbers. Other authentication methods may also be used.

In some embodiments, the location information and/or the audio-visual information may also be transmitted directly or indirectly (through a server, for example) to the mobile device when one or more conditions are met. For example, the vehicle may transmit the information to a server or directly to a mobile device when the vehicle is turned off. Thus, the last known location and audio-visual information are made available, even in cases where communication with the vehicle is not possible, for example. The mobile device, could request the newest available location information from the server. In other embodiments, the user may manually update the location of the vehicle on the server or mobile device, for example, by pressing a button or touching a button on a screen.

The mobile device, after receiving location information for the vehicle and after determining the current location of the mobile device, may provide a user with visual information, audible information, vibrational information, etc. indicating the relative location of the vehicle to the mobile device.

Visual feedback may be given in different ways. In some embodiments, the relative position of the vehicle may be displayed using one or more animated aids such as an arrow. In some embodiments, the arrow may be displayed over a map of the area. The map may be a street map, an aerial picture, a street-level map, etc. The arrow may point towards the relative direction of the vehicle to indicate the vehicle's relative latitude and longitude. To indicate relative distance from the vehicle, for example, thicker or thinner arrows may be used. To indicate elevation, the tip of the arrow may tilt out of the page to indicate that the vehicle is located relatively above the location of the mobile device and the tip of the arrow may tilt into the page to indicate that the vehicle is located relatively below the location of mobile device. Other visualizations of the relative position of the vehicle may also be employed. Numerical indicators may also be used such as an elevation indicator or a distance indicator. Other metrics may also be displayed in numerical format to assist the user in locating the vehicle.

Audio feedback may also be provided. For example, a beeping sound may be generated with the beeping frequency increasing as the distance to the vehicle decreases. Audible turn-by-turn directions may also be provided.

Vibrational feedback may also be provided. For example, the device may generate different vibration patterns with which to indicate the distance to the vehicle. In addition, different vibration patterns may be generated by the mobile device to indicate in which direction (left, right, forward, backward, etc.) relative to the mobile device the vehicle is located.

In addition, the user may, through hardware or software buttons on the mobile device, instruct the vehicle to flash its lights and/or honk the horn, for example, to further assist the user in locating the vehicle. In some embodiments, the lights and horn commands may be sent to the vehicle automatically when the mobile device is within some predetermined distance from the vehicle. In addition, in some embodiments, the system may be programmed to perform other actions when the user is within a certain distance from the vehicle such as turn the vehicle on, unlock the doors, turn on the air conditioning, etc. The user may also perform these actions with selections using the software running on the mobile device.

In some embodiments, to enable the mobile device to locate the vehicle, vehicle location software may be installed on the mobile device. In alternative embodiments, existing GPS software on mobile devices, such as phones or GPS units, may be used in locating the vehicle. The application may be written in the mobile device's native OS or it may be written in other languages such as Java.

In some embodiments, the mobile device could send a request for the vehicle's location, using a text message or TCP/IP, for example. If the vehicle is parked and turned off and perhaps in low-power, stand-by mode, the vehicle may first wake-up from the low power mode and then transmit the vehicle's updated current location to the mobile device instead of transmitting the last known position. An updated position may be preferred, for example, in cases where the vehicle has been moved since the last ignition cycle. If the vehicle does not respond, the mobile device may request the last known vehicle location from the server.

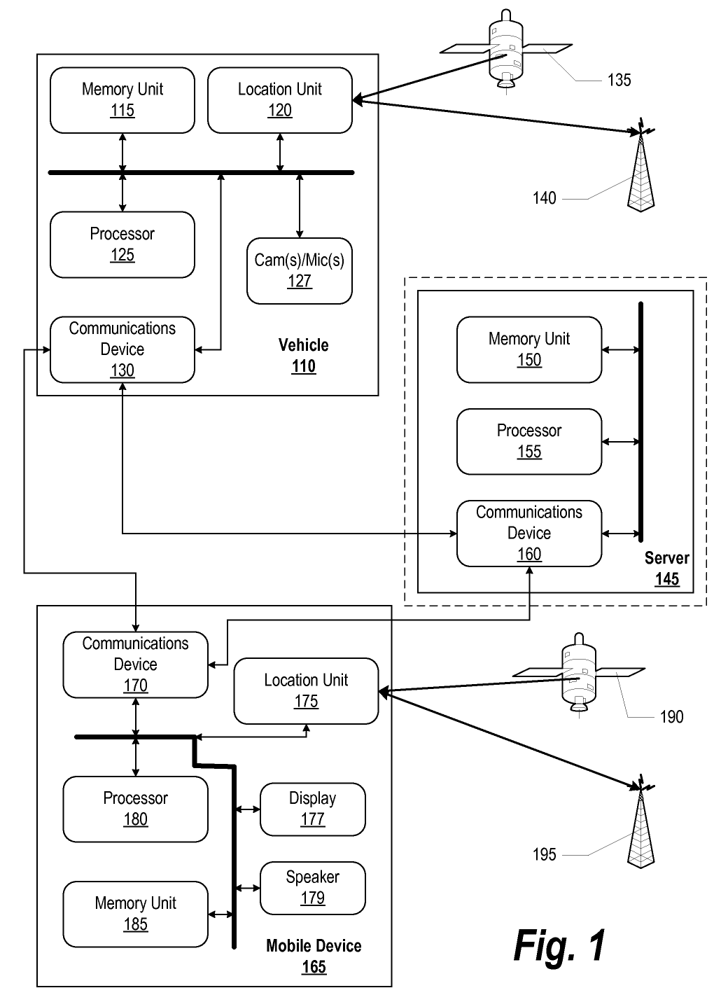

FIG. 1 is a block diagram illustrating a system for sending location and/or audio-visual information from a vehicle to a mobile device, in accordance with some embodiments.

In some embodiments, vehicle 110 is configured to send location information and/or audio-visual information to mobile device 165. Vehicle 110 may communicate directly with mobile device 165 or vehicle 110 may communicate the information to mobile device 165 through server 145.

In some embodiments, vehicle 110 comprises processor 125, memory unit 115, location unit 120, communications device 130, and cameras and microphones 127, all of which are directly or indirectly coupled to each other. Processor 125 is configured to perform computations and general control operations and memory unit 115 is configured to store data using non-volatile memory, volatile memory, or both. Location unit 120 is configured to determine the location of the vehicle. In some embodiments, location unit 120 is configured to receive GPS signals from one or more satellites, such as satellite 135, and to compute a location of the vehicle using the received signals. In alternative embodiments, location unit 120 may also be configured to communicate with one or more cellular phone towers, such as cellular tower 140, in assisted GPS (aGPS) mode in order to enhance the accuracy and/or reduce time in acquiring a location for the vehicle.

Communications device is configured to enable vehicle 110 to communicate with other devices such as mobile device 165 and server 145. In some embodiments, the communications may be performed using different communication protocols such as packet data or text messaging. One or more cameras and one or more microphones, such as cameras and microphones 127, may be used to capture audio and video at the vehicle. One or more cameras and one or more microphones may be placed inside and/or outside of the vehicle to capture audio and video from inside and/or outside of the vehicle.

In some embodiments, mobile device 165 comprises processor 180, memory unit 185, communications device 170, and location unit 175. Processor 180 is configured to perform computations and general control operations and memory unit 185 is configured to store data using non-volatile and/or volatile memory. Communications device 170 is configured to enable mobile device 165 to communicate directly with vehicle 110 and/or indirectly through server 145. In some embodiments, the communications may be performed using different communication protocols such as packet data or text messaging. Furthermore, the communications may be encrypted in order to secure the communications between mobile device 165, server 145, and vehicle 110. In some embodiments, mobile device 165 may be authenticated prior to communicating any information to either vehicle 110 or server 145. The authentication may be incorporated into the encryption process. In other embodiments, a simple password may be used. In yet other embodiments, the telephone number associated with the mobile device (in embodiments where the mobile device is mobile phone) may be used for the authentication process as described above.

Location unit 175 is configured to determine the location of mobile device 165. In some embodiments, location unit 175, similarly to location unit 120, may be configured to receive GPS signals from one or more satellites, such as satellite 190, and to compute a location of the mobile device using the received signals. In alternative embodiments, location unit 175 may also be configured to communicate with one or more cellular towers, such as cellular tower 195, in assisted GPS (aGPS) mode in order to enhance the accuracy and/or reduce the time required to acquire a location for the mobile device.

In some embodiments, server 145 comprises processor 155, memory unit 150, and communications device 160. Processor 155 is configured to perform computations and general control operations and memory unit 150 is configured to store data using non-volatile and/or volatile memory. Communications device 160 is configured to enable server 145 to communicate with vehicle 110 as well as mobile device 165 using different communication protocols.

In some embodiments, server 145 is configured to receive and store location information and/or audio-visual information from vehicle 110 and store the information, along with a time and date stamp and other attributes, in memory unit 150. Server 145 is further configured to provide the information to mobile device 165. The information may be provided to mobile device 165 at regular intervals, upon request by the mobile device, or upon being triggered by a particular event. In some embodiments, server 145 authenticates mobile device 165 before providing any information. Authentication may be performed using a password, by recognizing a phone number associated with the mobile device, etc.

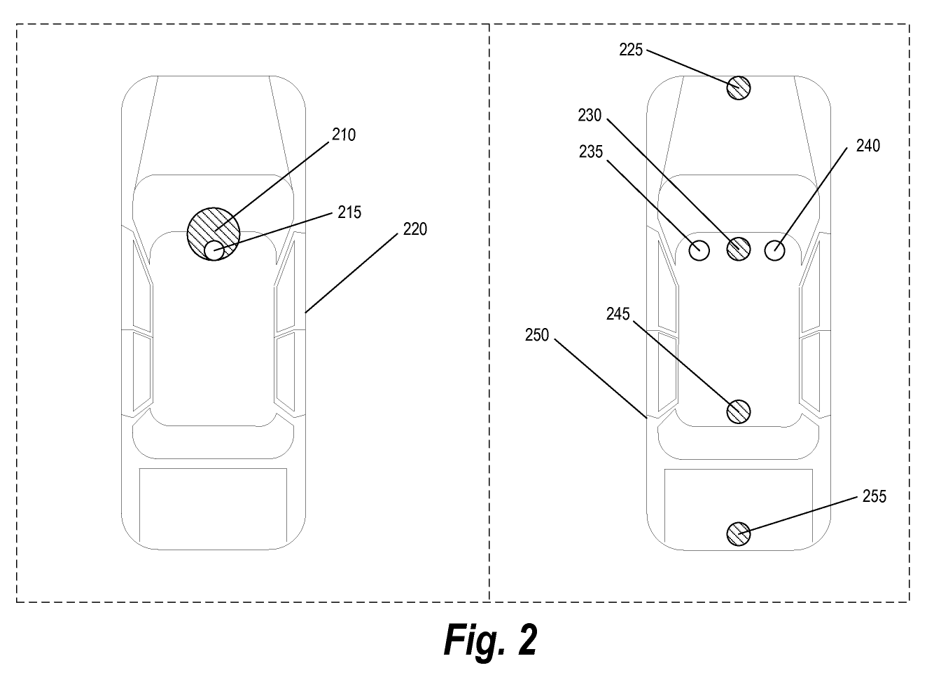

FIG. 2 is a block diagram illustrating alternative embodiments of a vehicle having one or more cameras and one or more microphones for capturing and sending audio-visual information to a mobile device, in accordance with some embodiments.

In some embodiments, a single camera and microphone may be used in vehicle 220 in order to capture audio and video from vehicle 220. The audio and video may be transmitted, directly or indirectly, to a mobile device. Camera 210 and microphone 215 may be mounted inside vehicle 220 and may be configured to capture audio and video from inside and outside vehicle 220. In other embodiments, multiple cameras may be used as well as multiple microphones for capturing video and audio from inside and outside of the vehicle. Other types of cameras may also be used, such as a 360-degree view camera. Various types of microphones may also be used.

In alternative embodiments, multiple cameras and microphones may be placed around the vehicle, such as vehicle 250. For example, camera 225 may be placed outside and in the front of vehicle 250 for capturing video from the front of vehicle 250 and camera 255 may be placed outside and to the back of vehicle 250 for capturing video from the back of vehicle 250. Camera 230 may be placed inside and in the front of vehicle 250 for capturing video from inside the front of vehicle 250 and camera 245 may be placed inside and to the back of vehicle 250 for capturing video from the back of vehicle 245.

One or more microphones, such as microphone 235 and microphone 240, may be placed in different locations inside and/or outside of the vehicle to capture and transmit sound from inside and/or outside of the vehicle to one or more mobile devices.

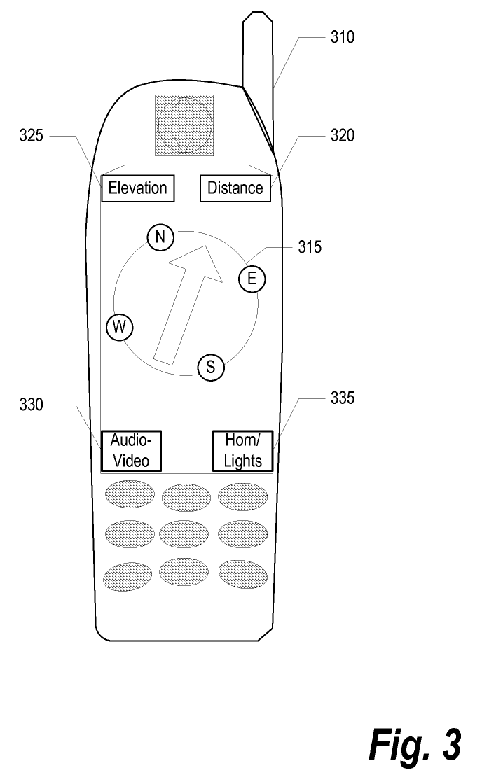

FIG. 3 is a block diagram illustrating a mobile device configured to receive location and/or visual information from a vehicle for the purpose of locating the vehicle, in accordance with some embodiments.

In some embodiments, mobile device 310 is configured to receive vehicle location information from a vehicle, determine the location of the mobile device, and thereby determine a relative location of the vehicle to mobile device 310.

In some embodiments, the relative position of the vehicle may be displayed using one or more animated aids such as arrow 315. The arrow may, for example, point towards the relative direction of the vehicle to indicate relative the vehicle's relative latitude and longitude to the mobile device. To indicate relative distance of the vehicle, for example, thicker or thinner arrows may be used. To indicate elevation, the tip of the arrow may tilt out of the page to indicate that the vehicle is located relatively above the location of mobile device 310, and the tip of the arrow may tilt into the page to indicate that the vehicle is located relatively below the location of mobile device 310. Other visualizations of the relative position of the vehicle may also be employed. In some embodiments, the arrow may be overlaid on a compass and/or a map of the area. Numerical indicators may also be used such as elevation indicator 325 and distance indicator 320. Other metrics may also be displayed in numerical format to assist a user in locating the vehicle.

In addition to the visual feedback, audio feedback may also be provided. For example, a beeping sound may be generated having a frequency that becomes higher as the distance to the vehicle decreases. In other embodiments, the sound may be altered in alternative ways to indicate a change in the relative distance or direction of the vehicle from mobile device 310.

Vibrational feedback may also be provided. For example, mobile device 310 may generate different vibration patterns with which to indicate the distance to the vehicle. In addition, different vibration patterns may be generated by mobile device 310 to indicate in which direction (left, right, forward, backward, etc.) the user needs to turn to head towards the vehicle.

In some embodiments, mobile device 310 may provide one or more buttons (in software or hardware) to allow a user to provide input. For example, button 335 may enable a user to activate the horn and/or the lights on the vehicle in order to aid the user in locating the vehicle. Button 330 may, for example, enable the user to display audio and video from the vehicle on mobile device 310. The audio and the video may be used to assist the user in locating the vehicle. The audio and video provided by the vehicle may also be used for other purposes. For example, the audio and video may be used in recovering the vehicle if the vehicle is stolen.

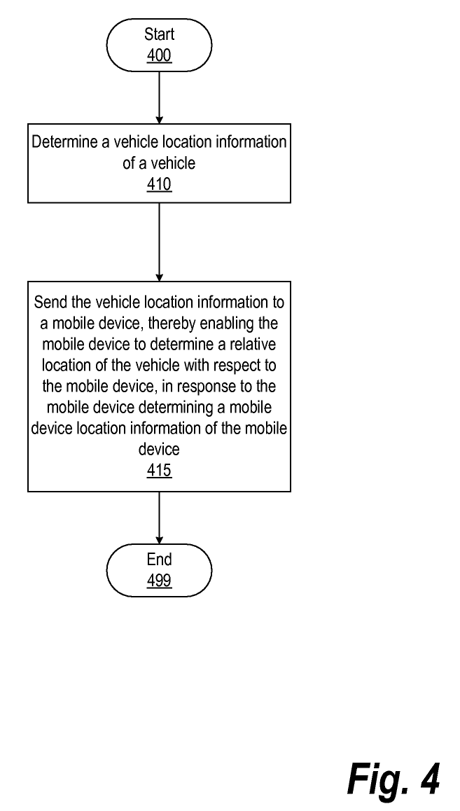

FIG. 4 is a flow diagram illustrating a method for sending location information from a vehicle to a mobile device, in accordance with some embodiments. In some embodiments, the method illustrated in FIG. 4 may be performed by one or more of the devices illustrated in FIG. 1, FIG. 2, and FIG. 3. Processing begins at 400 whereupon, at block 410, the vehicle location information of a vehicle is determined. At block 415, the vehicle location information is sent to a mobile device. The mobile device is thereby enabled to determine a relative position of the vehicle to the mobile device in response to the mobile device determining a mobile device location information for the mobile device. Processing subsequently ends at 499.

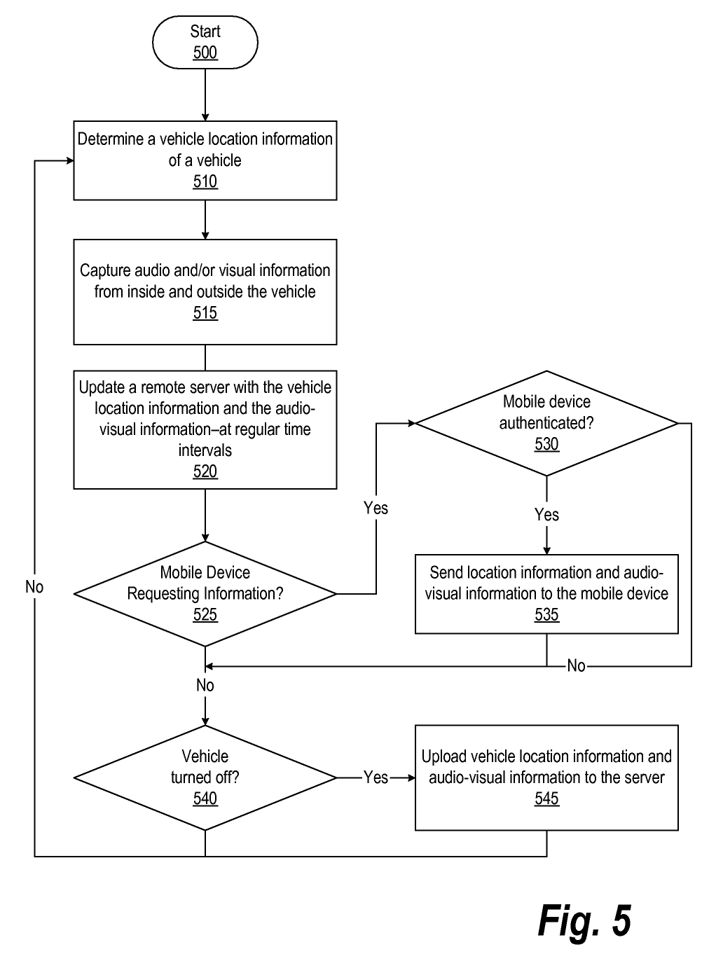

FIG. 5 is a flow diagram illustrating a method for sending location and/or audio-visual information to a mobile device, in accordance with some embodiments. In some embodiments, the method illustrated in FIG. 5 may be performed by one or more of the devices illustrated in FIG. 1, FIG. 2, and FIG. 3.

Processing begins at 500 whereupon, at block 510, a vehicle location information of a vehicle is determined. In some embodiments, the vehicle location information may be determined using GPS signals and/or signals from one or more cellular phone towers. The location information may be used by a mobile device to locate the vehicle.

At block 515, audio and/or visual information from inside and/or outside of the vehicle is captured. In some embodiments, audio and/or visual information may be captured using one or more cameras and microphones placed inside and/or outside the vehicle. The audio and visual information may additionally assist a user of a mobile device to locate the vehicle.

At block 520, a remote server is updated with location information and/or audio-visual information from the vehicle at regular intervals. In some embodiments, the information may be stored on the server in order to make the information available to a mobile device at later time. The mobile device may use the information to locate the vehicle at times when direct communication with the vehicle is not possible.

At decision 525, a determination is made as to whether a mobile device is requesting information. The information may include location information as well as audio and/or video information. If a mobile device is requesting information, decision 525 branches to the “yes” branch where, at decision 530, a determination is made as to whether the mobile device has been authenticated. The mobile device may be authenticated using different methods, such as a user ID and password, mobile telephone number identification, encryption, etc.

If the mobile device has been authenticated, decision 530 branches to the “yes” branch where, at block 525, location information and/or audio-visual information is sent to the mobile device. Processing subsequently continues at decision 540. Returning to decision 530, if the mobile device has not been authenticated, decision 530 branches to the “no” branch, whereupon processing again continues at decision 540.

Returning to decision 525, if the mobile device is not requesting information, decision 525 branches to the “no” branch where, at decision 540, a determination is made as to whether the vehicle has been turned off. If the vehicle has been turned off, decision 540 branches to the “yes” branch where, at block 545, vehicle location information and audio-visual information is uploaded to the server. In some embodiments, the information may be uploaded to the server so that the information may be recovered by a mobile device at a later time. On the other hand, if the vehicle has not been turned off, decision 540 branches to the “no” branch and processing returns to block 510.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A method for locating a vehicle, the method comprising:
determining a vehicle location information of a vehicle;
sending the vehicle location information to a mobile device, thereby enabling the mobile device to determine a relative location of the vehicle with respect to the mobile device, in response to the mobile device determining a mobile device location information of the mobile device.

2. The method of claim 1, where sending the vehicle location information comprises at least one of: sending the vehicle location information to the mobile device using packet data, sending the vehicle location information to the mobile device using text messaging, and sending the location information through a server.

3. The method of claim 1, where determining the vehicle and the mobile device location information comprises at least one of: using GPS signals technology, and using assisted GPS technology.

4. The method of claim 3, further comprising employing dead reckoning algorithms to determine the vehicle and the mobile device location information.

5. The method of claim 1, further comprising uploading the vehicle location information to a server in response to turning off the vehicle.

6. The method of claim 1, further comprising sending audio-visual information from inside and/or outside the vehicle to the mobile device.

7. The method of claim 1, further comprising authorizing the mobile device prior to sending the vehicle location information to the mobile device.

8. An apparatus for locating a vehicle, the apparatus comprising:
one or more processors;
one or more memory units coupled to the one or more processors;
a location unit coupled to the one or more processors, the location unit being configured to receive one or more external signals for determining a location of the apparatus; and
a communications device coupled to the one or more processors, the communications device being configured to communicate with a mobile device,
the apparatus being configured to:
determine a location information of the vehicle into which the apparatus is comprised;
send the vehicle location information to the mobile device, thereby enabling the mobile device to determine a relative location of the apparatus with respect to the mobile device, in response to the mobile device determining a mobile device location information of the mobile device.

9. The apparatus of claim 8, where the apparatus being configured to send the vehicle location information comprises the apparatus being configured to perform at least one of: send the vehicle location information to the mobile device using packet data, send the vehicle location information to the mobile device using text messaging, and send the location information through a server.

10. The apparatus of claim 8, where the location device is configured to receive at one of: GPS signals, and location information signals from one or more cellular towers.

11. The apparatus of claim 10, where the apparatus is further configured to employ dead reckoning algorithms to determine the vehicle location information.

12. The apparatus of claim 8, where the apparatus is further configured to upload the vehicle location information to a server in response to the vehicle being turned off.

13. The apparatus of claim 8, further comprising one or more cameras and one or more microphones for capturing and transmitting to the mobile device video, pictures, and audio.

14. The apparatus of claim 8, where the apparatus is further configured to authorize the mobile device prior to sending the vehicle location information to the mobile device.

15. A mobile device for locating a vehicle, the mobile device comprising:
one or more processors;
one or more memory units coupled to the one or more processors;
a location unit coupled to the one or more processors, the location unit being configured to receive one or more external signals for determining a location of the mobile device; and
a communications device coupled to the one or more processors, the communications device being configured to communicate with the vehicle,
the mobile device being configured to:
receive a vehicle location information from the vehicle;
determine a location information of the mobile device;
determine a relative location of the vehicle with respect to the mobile device.

16. The mobile device of claim 15, where the mobile device is configured to receive the vehicle location information comprises using at least one of: packet data, text messaging, and using a server as an intermediary.

17. The mobile device of claim 15, where the location device is configured to receive at one of: GPS signals, and location information signals from one or more cellular towers.

18. The mobile device of claim 15, where the mobile device is further configured to receive video, pictures, and audio from the vehicle.

19. The mobile device of claim 15, where the mobile device is further configured to send authorization information to the vehicle.

20. The mobile device of claim 15, where the mobile device is further configured to indicate the location information of the vehicle using at least one of: visual feedback, audio feedback, and vibrational feedback.
